(19) United States
(12) Patent Application Publication
(10) Pub. No.: US 2009/0135211 A1
(43) Pub. Date: May 28, 2009

(54) IMAGE DISPLAYING SYSTEM AND METHOD FOR ELIMINATING MURA DEFECT

(75) Inventors: Shou-Cheng Wang, Jhubei City (TW); Du-Zen Peng, Jhubei City (TW)

Correspondence Address: VENABLE LLP, P.O. BOX 34385, WASHINGTON, DC, 20043-9998, US

(73) Assignee: TPO Displays Corp., Chu-Nan (TW)

(21) Appl. No.: 12/261,569

(22) Filed: Oct. 30, 2008

(30) Foreign Application Priority Data
Nov. 26, 2007 (TW) 096144742

(51) Int. Cl. G09G 5/10

(52) U.S. Cl. 345/690

(57) ABSTRACT

Image displaying systems comprising a pixel array, a memory, a parameter selector and a compensator. The memory stores compensation parameter sets of a plurality of specific pixels of the pixel array. According to driving signals of the pixel array, the parameter selector determines a target pixel that the system is going to drive, and then determines whether the target pixel is one of the specific pixels andrequires to be compensated for mura defect. When the target pixel is one of the specific pixels and requires to be compensated for mura defect, the parameter selector outputs a memory address for retrieving the corresponding compensation parameter set from the memory. Based on the retrieved compensation parameter set and an original gray level of the target pixel, the compensator generates a compensated gray level to replace the original gray level to drive the target pixel.

### CROSS REFERENCE TO RELATED APPILCATIONS

This application claims the benefit of Taiwan Patent Application No. 096144742, filed Nov. 26, 2007, the entirety of which is incorporated by reference herein.

### BACKGROUND OF THE INVENTION

1. Field of the Invention

The invention relates to image displaying systems and methods for eliminating mura defect.

2. Description of the Related Art

Image displaying systems generally comprise a pixel array comprising a plurality of pixels. The luminosities of the pixels may be affected by manufacturing variations of the pixel array, such that mura defect is generated. For example, when driving all the pixels to display one specific gray level, the pixels may show uneven brightness—some pixels are brighter than others.

One solution to mura defect is external mura defect compensation. The conventional technique analyzes the electronic or optical characteristics of every pixel to provide each pixel with a compensation parameter set, store the compensation parameter set in a memory, and retrieve the compensation parameter sets for mura defect compensation when driving the pixel array. Before driving of a pixel, the conventional technique generates a compensated gray level based on the retrieved compensation parameter set and an original gray level of the pixel. To compensate for mura defect, the pixel is driven by the compensated gray level instead of its original gray level.

The conventional technique adjusts every pixel of the pixel array. Thus, much memory is required to store the compensation parameter sets of all the pixels. As such, with the trend for larger and larger high-resolution and high refresh rate image display systems, relative costs due to memory requirements and performance hindrance due to memory transmission bandwidth are increasing.

For an image displaying system with Quarter Video Graphics Array (QVGA) resolution (240×320), there are four types of sub-pixels (R, G, B and W) and operates with a refresh rate of 60 fps. In a case wherein each sub-pixel relates to a compensation parameter set comprising two parameters, the transmitting bandwidth of the memory will be 36.9 MHz (240×320×4×60×2). Meanwhile, for an image displaying system with Video Graphic Array (VGA) resolution, the transmitting bandwidth of Utilizing high-speed memory increases costs for conventional mura compensation method. A the memory may be up to 147 MHz. dditionally, due to the high-speed memory transmissions, power consumption of QVGA or VGA image displaying systems will increase and application in portable electronic devices is hindered.

Conventional solutions for large memory transmissions comprise: increasing the output pins of the memory; decreasing the fresh rate of the displaying device; or using multiple memories. However, increasing the output pins of the memory (such as using a memory with 16 parallel output pins to replace a memory with 8 pins or serial outputs) raises costs and may lower manufacturing yield, decreasing the fresh rate may lower video quality, and using a multiple memory structure may increase costs and circuit size.

Therefore, mura defect compensation techniques with low memory transmission and low power consumption are called for.

### BRIEF SUMMARY OF THE INVENTION

The invention discloses image displaying systems. An exemplary embodiment of the image displaying system comprises a pixel array, a memory, a parameter selector and a compensator. The memory stores compensation parameter sets of a plurality of specific pixels of the pixel array. According to driving signals of the pixel array, the parameter selector determines a target pixel and then determines whether the target pixel is one of the specific pixels and requires to be compensated for mura defect, wherein the target pixel is the pixel that the image displaying system is going to drive. When the target pixel is one of the specific pixels and requires to be compensated for mura defect, the parameter selector outputs a memory address for retrieving the corresponding compensation parameter set from the memory. Based on the retrieved compensation parameter set and an original gray level of the target pixel, the compensator generates a compensated gray level to replace the original gray level to drive the target pixel.

An exemplary embodiment of the invention further discloses methods for eliminating mura defect, comprising: using a memory to store compensation parameter sets of a plurality of specific pixels of a pixel array; analyzing driving signals of the pixel array to determine a target pixel going to be driven by driving circuits of the panel; determining whether the target pixel is one of the specific pixels and requires to be compensated for mura defect, and generating a memory address for retrieving the corresponding compensation parameter set from the memory when the target pixel is one of the specific pixels and requires to be compensated for mura defect; and generating a compensated gray level based on the retrieved compensation parameter set and an original gray level of the target pixel and using the compensated gray level to replace the original gray level to drive the target pixel.

The above and other advantages will become more apparent with reference to the following description taken in conjunction with the accompanying drawings.

### BRIEF DESCRIPTION OF THE DRAWINGS

The invention can be more fully understood by reading the subsequent detailed description and examples with references made to the accompanying drawings, wherein:

FIG. 1 illustrates an embodiment of the image displaying system of the invention;

FIG. 2 illustrates another embodiment of the invention;

FIG. 3 illustrates an embodiment of the parameter selector of the invention;

FIG. 4 illustrates an image frame displayed by a mobile phone;

FIG. 5 illustrates an embodiment of the invention;

FIG. 6 illustrates another embodiment of the parameter selector of the invention;

FIG. 7 illustrates an embodiment of the invention; and

FIG. 8 is a flowchart of an embodiment of the mura defect eliminating method.

### DETAILED DESCRIPTION OF THE INVENTION

The following description shows some embodiments carrying out the invention. This description is made for the purpose of illustrating the general principles of the invention and should not be taken in a limiting sense. The scope of the invention is best determined by reference to the appended claims.

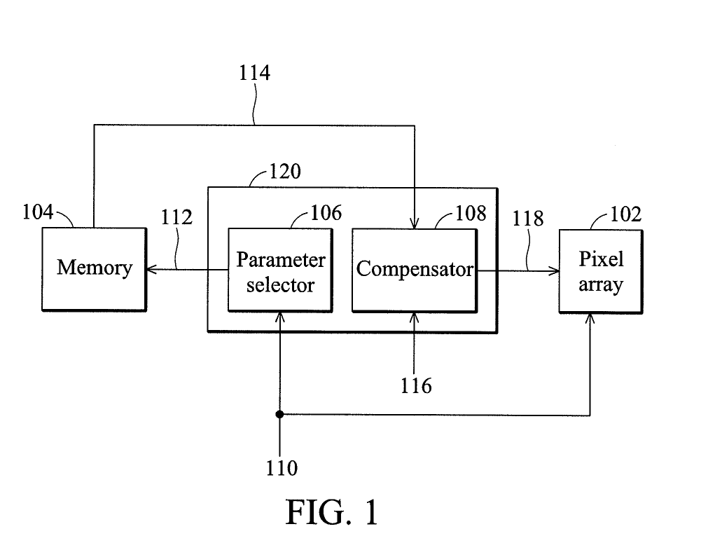

FIG. 1 illustrates an embodiment of the image displaying system of the invention. The image displaying system comprises a pixel array 102, a memory 104, a parameter selector 106 and a compensator 108. The pixel array 102 comprises a plurality of pixels. The memory 104 stores compensation parameter sets of a plurality of specific pixels of the pixel array 102. The specific pixels may be selected by the designer. The parameter selector 106 receives driving signals 110 of the pixel array 102, and determines a target pixel going to be driven by the image displaying system. The parameter selector 106 determines whether the target pixel is one of the specific pixels and requires to be compensated for mura defect and, when the target pixel is one of the specific pixels and requires to be compensated for mura defect, the parameter selector 106 outputs a memory address 112 for retrieving the corresponding compensation parameter set from the memory 104. The signal 114 is the retrieved compensation parameter set. Based on the compensation parameter set 114 and an original gray level 116 of the target pixel, the compensator 108 generates a compensated gray level 118. Instead of the original gray level 116, the compensated gray level 118 is used in driving the target pixel. In the embodiment of FIG. 1, the parameter selector 106 and the compensator 108 is combined in a module 120 for external mura defect compensation.

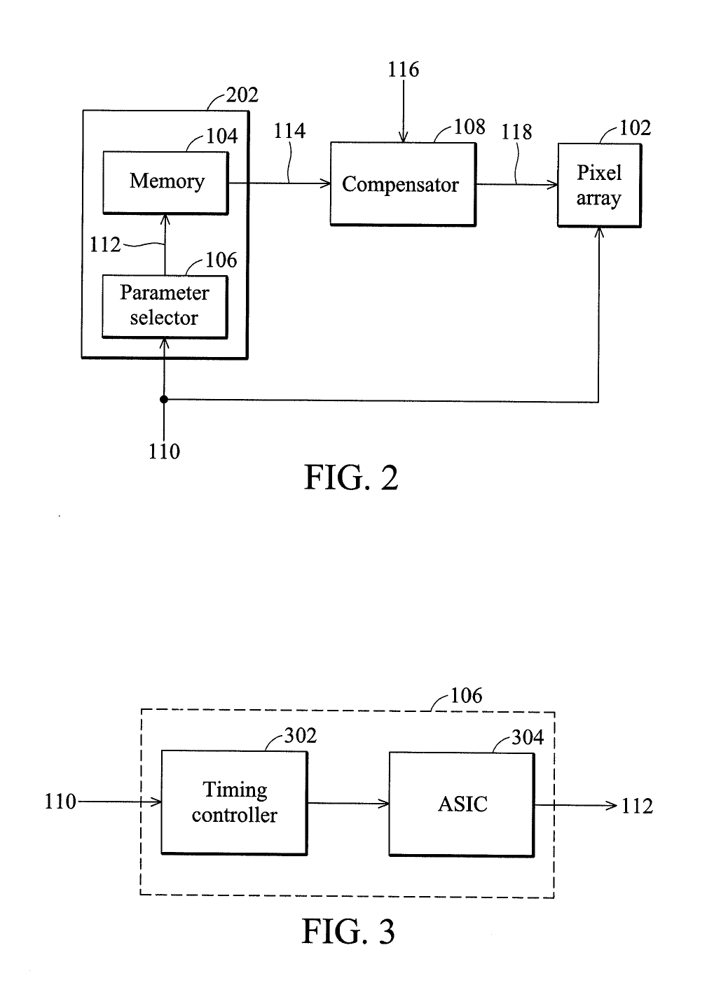

FIG. 2 illustrates another embodiment of the image displaying system, wherein the parameter selector 106 and the memory 104 are combined in a memory module 202.

FIG. 3 illustrates an embodiment of the parameter selector 106, which comprises a timing controller 302 and an ASIC 304. The timing controller 302 receives the driving signals 110 of the pixel array 102, and outputs the target pixel to the ASIC 304. The ASIC 304 determines whether the target pixel is one of the specific pixels and requires to be compensated for mura defect and outputs memory address 112 when the target pixel is one of the specific pixels and requires to be compensated for mura defect.

In some embodiments, to decrease the transmission quantity of the memory 104, the invention only adjusts the pixels of a specific color, such as green, the most sensitive color for human vision. In these cases, the pixels of the specific color are defined as the specific pixels of the invention. The ASIC 304 determines that the target pixel is one of the specific pixels and requires to be compensated for mura defect when the target pixel is designed to display this specific color. The memory 104 may only store the compensation parameter sets of the pixels of the specific color. Thus, the memory size and the transmission quantity of the memory 104 can be decreased. In other embodiments, the specific color may be other colors such as red, blue or white. The choice of the specific color is dependent on the electronic or optical characteristics of the pixels. In other embodiments, the image displaying system may set more than one colors as the specific colors (such as green and white), if the memory thereof provides enough space and transmission quantity.

In some embodiment, each image frame relates to one specific color. For example, a first image frame relates to a first specific color and a second frame relates to a second specific color, and pixels of the first or second specific colors are defined as the specific pixels of the invention. For the first image frame, the parameter selector 106 determines that the target pixel is one of the specific pixels and requires to be compensated for mura defect when the target pixel is of the first specific color. For the second image frame, the parameter selector 106 determines that the is one of the specific pixels and target pixel requires to be compensated when the target pixel is of the second specific color. Compared to conventional techniques which retrieve all compensation parameter sets for each image frame, the embodiments of the invention only retrieve part of the compensation parameter sets for each image frame. The embodiments have lower memory transmission quantities. In an example of a QVGA image displaying system, the ASIC 304 determines that the pixels of red requires to be compensated for mura defect when the image displaying system is displaying a first image frame, determines that the pixels of green requires to be compensated for mura defect when the system is displaying a second image frame, determines that the pixels of blue requires to be compensated for mura defect when the system is displaying a third image frame, and determines that the pixels of white requires to be compensated for mura defect when the system is displaying a fourth frame. This routine is repeated during image displaying. Compared to the conventional techniques which compensate R, G, B and W pixels for each image frame, the invention lowers transmission quantity of the memory by 75% of that of the conventional technique and dramatically lowers power consumption.

In some embodiments, the invention compensates the pixels on the odd-numbered lines and the pixels on the even-numbered lines in different image frames. When the system is displaying a first image frame, the ASIC 304 determines that the pixels of odd-numbered lines require to be compensated for mura defect. When the system is displaying a second image frame, the ASIC 304 determines that the pixels of even-numbered lines require to be compensated for mura defect. Compared to conventional techniques which compensates all pixels in each image frame, this embodiment lowers the transmission quantity by 50%.

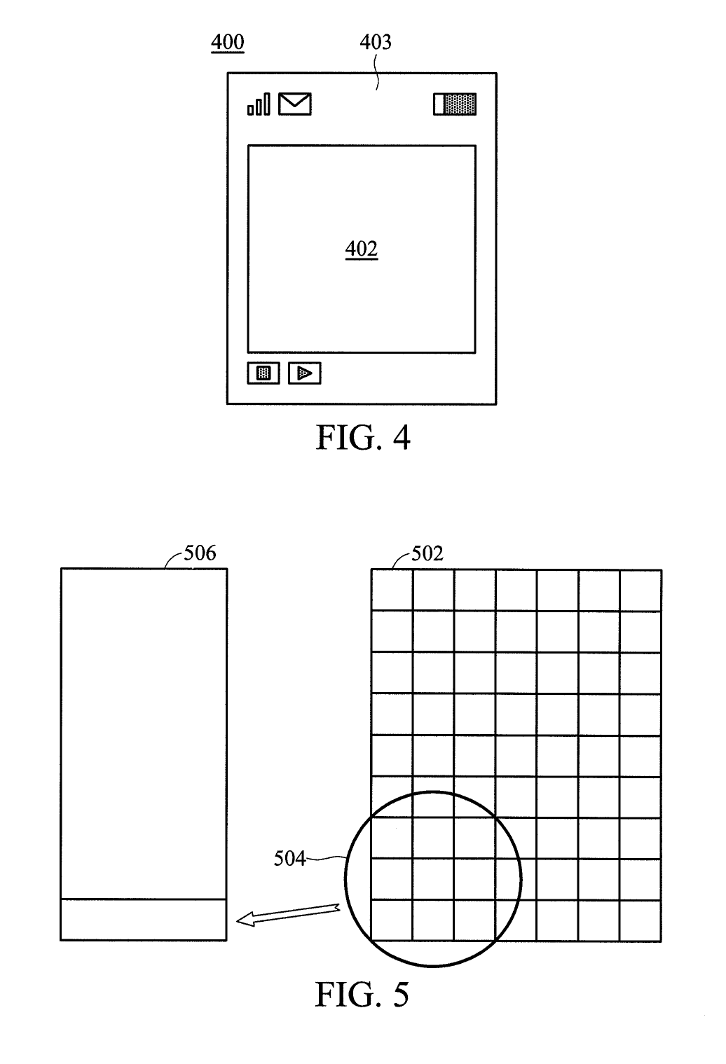

Another exemplary embodiment of the invention only compensates the pixels displaying static images since compared to dynamic video, human vision is more sensitive to the mura defect of static images. Compared to conventional techniques that compensate all pixels, the embodiment dramatically lowers the transmission quantity of the memory 104. FIG. 4 illustrates an image frame 400 displayed by a mobile phone, which comprises a dynamic video region 402 and a static image region 403. The static image region 403 shows generally static icons such as an antenna icon, a mail icon, a battery icon. In the embodiments, the memory 104 may only store the compensation parameter sets of the pixels in the static image region 403. Thus, a smaller sized memory 104 can be utilized to meet operational requirements.

The mura defect is dependent upon the manufacturing variations and circuit layout of the pixel array. Thus, not every pixel of the pixel array requires the mura defect compensation. Another exemplary embodiment of the invention only compensates the pixels with obvious mura defects (more serious than a standard). For example, the pixels with obvious mura defects may locate near the center of the pixel array. This embodiment can effectively reduce the mura defect and only require a smaller sized memory with low transmission bandwidth.

Another exemplary embodiment of the invention only compensates the pixels with the shortest operating lifetime (or shorter than a threshold value). The operating lifetime of a pixel is dependent upon the circuit layout and electronic characteristics of the pixel. A pixel with the shortest operating lifetime may have poor luminosity. Generally, the pixels with the shortest operating lifetime are located in some specific regions. In these cases, the pixels located in the specific regions are defined as the specific pixels of the invention. The parameter selector 106 may determine that the target pixels is one of the specific pixels and requires to be compensated for mura defect when the target pixel locates in the specific regions.

In some embodiments, the compensation parameter sets stored in the memory may be shared by several specific pixels. Thus, the memory size and the transmission quantity of the memory 104 can be dramatically decreased. Referring to FIG. 5, in the pixel array 502, pixels within region 504 are specific pixels and share a single compensation parameter set stored in the memory 506. Thus, only one memory retrieval process is required to compensate for the pixels within the region 504.

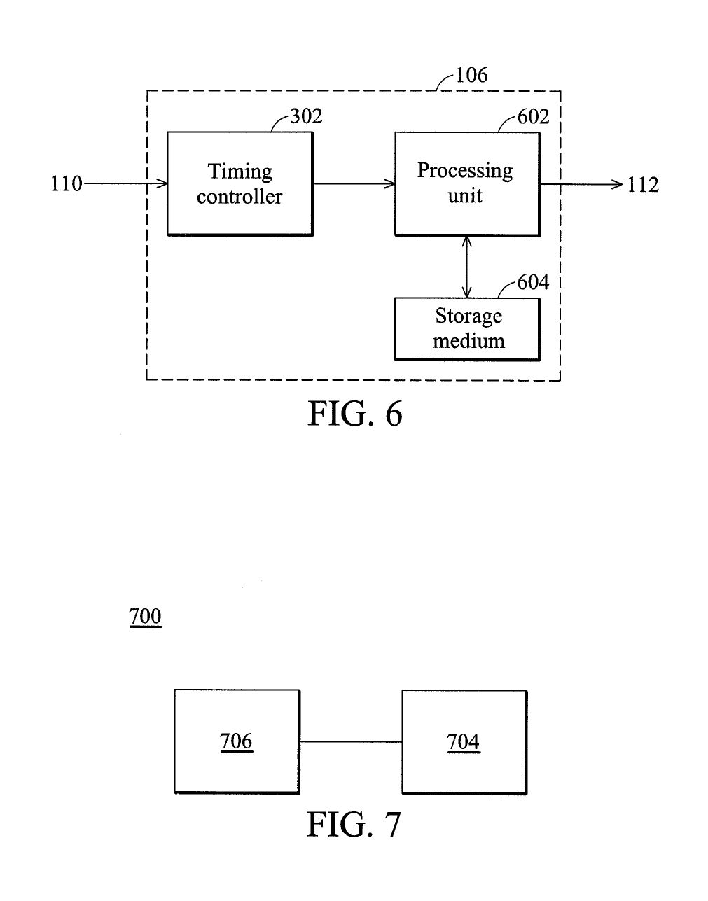

FIG. 6 illustrates another embodiment of the parameter selector 106. Compared to FIG. 3, the ASIC 304 is replaced by a processing unit 602 and a storage medium 604. The storage medium 604 stores a software program comprising the functions of the ASIC 304, and the software program is accessed and executed by the processing unit 602.

FIG. 7 illustrates another embodiment of the invention. An image displaying panel 704 comprises the aforementioned pixel array 102, the memory 104, the parameter selector 106 and the compensator 108 (shown in FIG. 1). The image displaying panel 704 may be installed in an electronic device 700. In addition to the image displaying panel 704, the electronic device 700 comprises an input unit 706 which receives images and transmits the images to the image displaying panel 704. The electronic device 700 may be a mobile phone, a digital camera, a PDA, a notebook, a desktop, a TV, a car display panel, a digital photo frame, a video display system of airbus, and a portable DVD player.

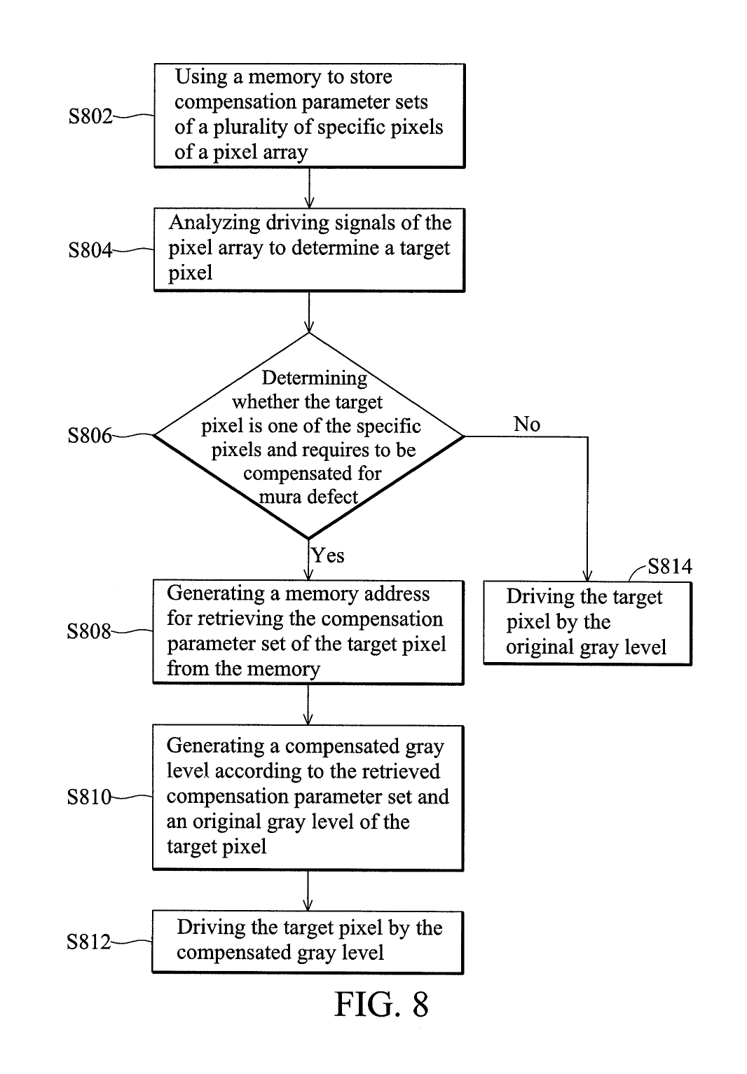

The invention further discloses methods for eliminating mura defect. FIG. 8 is a flowchart of an embodiment of the invention. In step S802, compensation parameter sets of a plurality of specific pixels of a pixel array are stored in a memory. The specific pixels are set by the user, and they may be the pixels with obvious mura defects. In step S804, a target pixel is determined according to driving signals of the pixel array. The target pixel is the pixel that the image displaying system is going to drive. In step S806, the method determines whether the target pixel is one of the specific pixels and requires to be compensated for mura defect. When the target pixel is one of the specific pixels and requires to be compensated for mura defect, the process enters step S808, wherein a memory address of the corresponding compensation parameter set is generated. In step S810, the compensation parameter set of the target pixel is retrieved from the memory according to the memory address generated in step S808, and a compensated gray level is generated based on the retrieved compensation parameter set and an original gray level of the target pixel. In step S812, instead of the original gray level, the compensated gray level is used to drive the target pixel. In another situation, when the target pixel does not have to be compensated for mura defect, the process enters step S814 to drive the target pixel by the original gray level thereof.

The invention further provides several rules for setting up the specific pixels. In some embodiments, the specific pixels are the pixels of a specific color. In other embodiments, each image frame relates to one specific pixel setting. At least one color is compensated for the mura defect during each frame time, and different image frames may compensate different color. For example, when displaying a first image frame, the pixels of a first specific color are compensated for mura defect, and when displaying a second image frame, the pixels of a second specific color are compensated for mura defect. In some embodiments, pixels on the odd-numbered lines of the pixel array are compensated during a first image frame, and the pixels on the even-numbered lines of the pixel array are compensated during a second image frame. In some embodiments, only the pixels within a static image region are compensated for the mura defect. In some embodiment, the pixels with operating lifetime shorter than a threshold value are determined as the specific pixels.

Furthermore, the invention discloses techniques for sharing the compensation parameter sets. For example, several pixels of the pixel array may share a single compensation parameter set, so that the memory size and the transmission quantity of the memory can be dramatically decreased.

The invention may provide high-resolution and high refresh rate image displaying systems with mura defect compensation. By using the techniques of the invention, the memory storing the compensation parameter sets can be realized by utilizing low cost memories.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded to the broadest interpretation so as to encompass all such modifications and similar arrangements.

What is claimed is:

1. An image displaying system, comprising:
a pixel array;
a memory, storing compensation parameter sets of a plurality of specific pixels of the pixel array;
a parameter selector, receiving driving signals of the pixel array to determine a target pixel that the image displaying system is going to drive, determining whether the target pixel is one of the specific pixels and requires to be compensated for mura defect, wherein the parameter selector outputs a memory address for retrieving the compensation parameter set of the target pixel from the memory when the target pixel is one of the specific pixel and requires to be compensated; and
a compensator, generating a compensated gray level according to the retrieved compensation parameter set and an original gray level of the target pixel, and using the compensated gray level to drive the target pixel.

2. The image displaying system as claimed in claim 1, wherein the specific pixels are of a specific color, and the parameter selector comprises an ASIC determining that the target pixel is one of the specific pixels and requires to be compensated for mura defect when the target pixel is of the specific color.

3. The image displaying system as claimed in claim 1, wherein the specific pixels are of first or second specific colors, and the parameter selector comprises an ASIC and, when the image displaying system is displaying a first image frame and the target pixel is of the first specific color, the ASIC determines that the target pixel is one of the specific pixels and requires to be compensated for mura defect, and when the image displaying system is displaying a second image frame and the target pixel is of the second specific color, the ASIC determines that the target pixel is one of the specific pixels and requires to be compensated for mura defect.

4. The image displaying system as claimed in claim 1, wherein the specific pixels are all pixels of the pixel array, and the parameter selector comprises an ASIC and, when the image displaying system is displaying a first image frame and the target pixel is on one of odd-numbered lines of the pixel array, the ASIC determines that the target pixel is one of the specific pixels and requires to be compensated for mura defect, and when the image displaying system is displaying a second image frame and the target pixel is on one of even-numbered lines of the pixel array, the ASIC determines that the target pixel is one of the specific pixels and requires to be compensated for mura defect.

5. The image displaying system as claimed in claim 1, wherein the specific pixels are pixels of a static image region of the pixel array, and the parameter selector comprises an ASIC determining that the target pixel is one of the specific pixels and requires to be compensated for mura defect when the target pixel is in the static image region.

6. The image displaying system as claimed in claim 1, wherein the specific pixels have mura defects more serious than a standard, and the parameter selector comprises an ASIC determining that the target pixel is one of the specific pixels and requires to be compensated for mura defect when the target pixel has mura defects more serious than the standard.

7. The image displaying system as claimed in claim 1, wherein the specific pixels have operating lifetime shorter than a threshold value, and the parameter selector comprises an ASIC determining that the target pixel is one of the specific pixels and requires to be compensated for mura defect when the operating lifetime of the target pixel is shorter than the threshold value.

8. The image displaying system as claimed in claim 1, wherein the compensation parameter sets stored in the memory are shared by the specific pixels.

9. The image displaying system as claimed in claim 1, wherein the parameter selector comprises a processing unit and a storage medium, and the storage medium is stored a software program determining whether the target pixel is one of the specific pixels and requires to be compensated for mura defect.

10. The image displaying system as claimed in claim 1, further comprising an image displaying panel comprising the pixel array, the memory, the parameter selector and the compensator.

11. The image displaying system as claimed in claim 10, further comprising:
the image displaying panel; and
an input unit, receiving videos and coupling the videos to the image displaying panel.

12. The image displaying system as claimed in claim 11, wherein the electronic device is a mobile phone, a digital camera, a PDA, a notebook, a desktop, a television, a car display device, a digital photo frame, a video display in an airplane or a portable DVD player.

13. A method for eliminating mura defect, comprising:
using a memory to store compensation parameter sets of a plurality of specific pixels of a pixel array;
analyzing driving signals of the pixel array to determine a target pixel;
determining whether the target pixel is one of the specific pixels and requires to be compensated for mura defect;
generating a memory address for retrieving the compensation parameter set of the target pixel from the memory when the target pixel is one of the specific pixels and requires to be compensated for mura defect;
generating a compensated gray level according to the retrieved compensation parameter set and an original gray level of the target pixel; and
driving the target pixel by the compensated gray level.

14. The method as claimed in claim 13, wherein the specific pixels are the pixels designed to display a specific color and, when the target pixel is of the specific color, the target pixel is determined to be one of the specific pixels and requiring to be compensated for mura defect.

15. The method as claimed in claim 13, wherein the specific pixels are of first or second specific colors and, when a first image frame is displaying and the target pixel is of the first specific color, the target pixel is determined to be one of the specific pixels and requiring to be compensated for mura defect and, when a second image frame is displaying and the target pixel is of the second specific color, the target pixel is determined to be one of the specific pixels and requiring to be compensated for mura defect.

16. The method as claimed in claim 13, wherein the specific pixels are all pixels of the pixel array and, when a first image frame is displaying and the target pixel is on one of odd-numbered lines of the pixel array, the target pixel is determined to be one of the specific pixels and requiring to be compensated for mura defect and, when a second image frame is displaying and the target pixel is on one of even-numbered lines of the pixel array, the target pixel is determined to be one of the specific pixels and requiring to be compensated for mura defect.

17. The method as claimed in claim 13, wherein the specific pixels are the pixels in a static image region of the pixel array, and the target pixel is determined to be one of the specific pixels and requiring to be compensated for mura defect when the target pixel is within the static image region.

18. The method as claimed in claim 13, wherein the specific pixels are the pixels with operating lifetime shorter than a threshold value, and the target pixel is determined to be one of the specific pixels and requiring to be compensated for mura defect when the target pixel has operation lifetime shorter than the threshold value.

19. The method as claimed in claim 13, wherein the compensation parameter sets stored in the memory are shared by the specific pixels.
